(19) United States
(12) Patent Application Publication
(10) Pub. No.: US 2013/0162210 A1
(43) Pub. Date: Jun. 27, 2013

(54) POWER SUPPLY SYSTEM AND RECHARGEABLE BATTERY USED IN THE SYSTEM

(71) Applicants: Hong Fu Jin Precision Industry (ShenZhen) Co., LTD., Shenzhen (CN); Hon Hai Precision Industry CO., LTD., New Taipei (TW)

(72) Inventors: CHIANG-KUO TANG, New Taipei (TW); YA-MING GUAN, Shenzhen (CN); ZHI-GUO LI, Shenzhen (CN); SHIN-HONG CHUNG, New Taipei (TW)

(73) Assignees: Hon Hai Precision Industry Co., LTD., New Taipei (TW); Hong Fu Jin Precision Industry (ShenZhen) Co., LTD., Shenzhen (CN)

(21) Appl. No.: 13/716,215

(22) Filed: Dec. 17, 2012

(30) Foreign Application Priority Data
Dec. 26, 2011 (CN) 201120550492.3

(51) Int. Cl. H01M 2/20; H02J 7/00

(52) U.S. Cl. CPC H01M 2/204; H02J 7/0013; H02J 7/0063
USPC 320/112; 429/91; 320/135

(57) ABSTRACT

A rechargeable battery includes a plug, a first socket, a capacity storage module and a power measurement module. The plug is configured for being plugged in either a first socket of a second similar rechargeable battery to constitute a battery pack or a second socket of a charge apparatus. In addition, the first socket either is configured for either receiving a plug of a third similar rechargeable battery to constitute the battery pack or being electrically coupled to a power input port of an electronic device. The power measurement module is electrically connected to the capacity storage module, and is configured to measure a residual capacity value of the capacity storage module, and feedback the measured residual capacity value to the charge apparatus. A related power supply system is also provided.

### BACKGROUND

1. Technical Field

The present disclosure relates to power supply system and rechargeable battery that is being used in the system.

2. Description of Related Art

Functions of portable electronic devices such as smart phones have become more versatile and more powerful. The powerful electronic devices consume more power, and time of use is therefore shortened. Such that, users usually need to carry one or more spare batteries. However, the capacity stored in these batteries is limited, and it is difficult for user to learn how much residual capacity all these batteries keep. As well these batteries do not support hot swapping, so users need to turn off the electronic device first, and then detach and replace batteries for these electronic devices, which interrupt the user's work and affect working efficiency.

Therefore, a power supply system, which overcomes the afore mentioned limitations is required.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a power supply system, according to a first embodiment.

FIG. 2 is a schematic view of the power supply system of FIG. 1, showing a charge apparatus and a number of rechargeable batteries.

FIG. 3(a) is a block diagram of the charge apparatus of FIG. 2, FIG. 3(b) is a block diagram of one of the rechargeable batteries of FIG. 2.

FIG. 4 is a circuit diagram of the power supply system of FIG. 3.

FIG. 5(a) is another block diagram of the charge apparatus, FIG. 5(b) is another block diagram of the rechargeable battery, according to a second embodiment.

### DETAILED DESCRIPTION

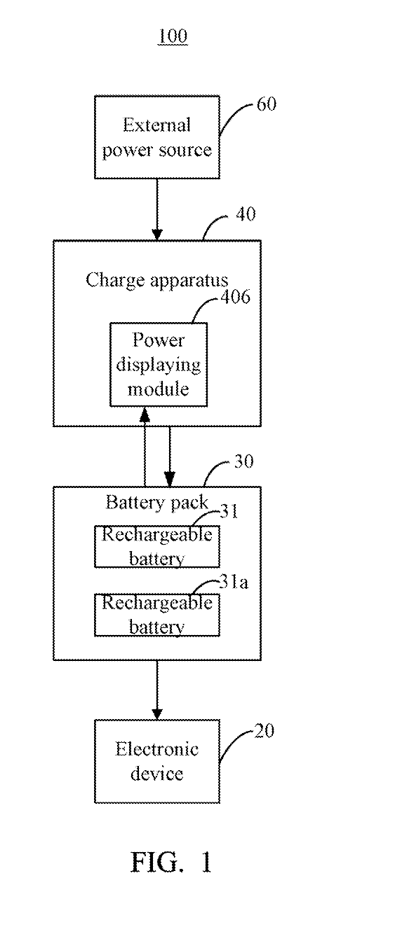

FIG. 1 shows a power supply system 100 of one embodiment. The power supply system 100 includes a portable electronic device 20, a battery pack 30 and a charge apparatus 40. The electronic device 20 includes but not limited to mobile phone, PDA, for example. The battery pack 30 includes a number of rechargeable batteries 31, and the battery pack 30 can be coupled to the charge apparatus 40 and the electronic device 20. The charge apparatus 40 is electrically connected to an external power source 60 to charge the rechargeable battery 31, and the battery pack 30 supplies power to the electronic device 20. In the embodiment, the battery pack 30 further feeds back its residual capacity value to the charge apparatus 40. The charge apparatus 40 includes a power displaying module 406, which is configured to display the residual capacity value of the battery pack 30, and indicate whether the battery pack 30 is full charged during a charging process. Therefore, users know how much power the battery pack 30 keeps.

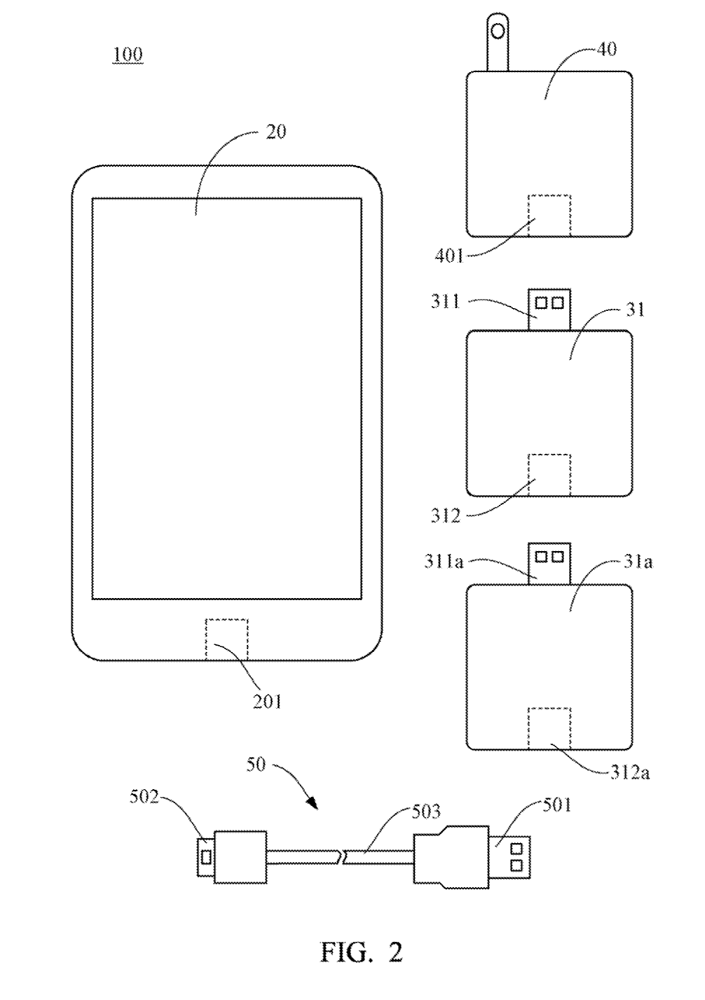

FIG. 2 shows that in the embodiment, the rechargeable battery 31 includes a plug 311 and a first socket 312. The plug 311 and the first socket 312 are set on opposite end surfaces of the rechargeable battery 31. A number of rechargeable batteries 31 can be assembled together by insertion of the plug 311 of one of these rechargeable batteries into the first socket 312 of another of these rechargeable batteries, to constitute the battery pack 30. Such as shown in FIG. 2, the plug 311a of the rechargeable battery 31a is plugged in the first socket 312 of the rechargeable battery 31, and the rechargeable battery 31a can thus be electrically connected to the rechargeable battery 31.

The charge apparatus 40 further includes a second socket 401, and an unoccupied plug 311 of the battery pack 30 is plugged in the second socket 401, to connect the battery pack 30 to the charge apparatus 40.

An unoccupied first socket of the battery pack 30 is coupled to a power input port 201 of the electronic device 20. In the embodiment, the power supply system 100 further includes a connecting apparatus 50, which includes a data transmission cable 503, and a first connector 501 and a second connector 502 electrically connected to two opposite ends of the data transmission cable 503. The first connector 501 is plugged in the first socket 312a of the rechargeable battery 31a, and the second connector 502 is plugged in the power input port 201 of the electronic device 20, then the battery pack 30 can supply power to the electronic device 20 via the connecting apparatus 50.

In the embodiment, the data transmission cable 503 is a USB cable, the plug 311, the first connector 501, and the second connector 502 are USB connectors, the first socket 312 and the second socket 401 are USB sockets. each of the USB connector and the USB socket includes a power pin VCC, a first data pin Data+, a second data pin Data-and a ground pin GND.

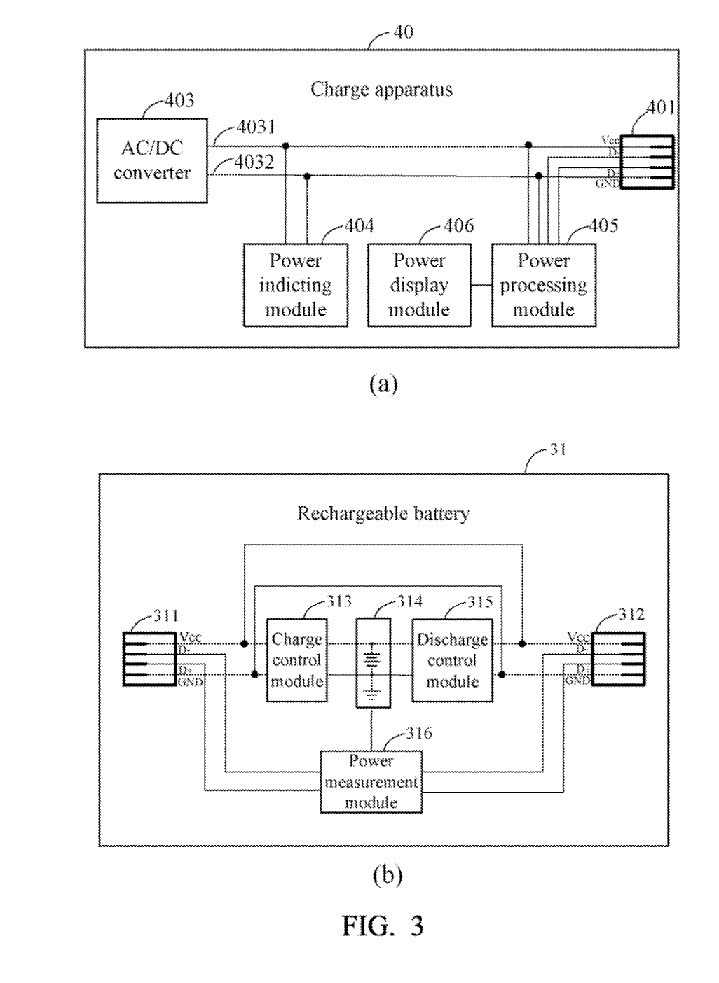

Referring to FIG. 3(a), the charge apparatus 40 further includes an alternating current to directing current (AC/DC) converter 403, a power indicating module 404, and a power processing module 405. The AC/DC converter 403 includes two voltage output pins 4031 and 4032, which electrically connect to the power pin VCC and the ground pin GND of the second socket 401 correspondingly. The AC/DC converter 403 is configured for converting an incoming high-voltage alternating current of the external power source 60 into a low-voltage directing current, and outputting the low-voltage directing current to the power pin VCC and the ground pin GND of the second socket 401. The power indicting module 404 is provided on a surface of the charge apparatus 40, and is electrically connected to the voltage output pins 4031 and 4032 of the AC/DC converter 403. The power indicting module 404 is configured for indicating a connection status between the charge apparatus 40 and the external power source 60.

The power processing module 405 is electrically connected to the voltage output pins 4031 and 4032 of the AC/DC converter 403 and the first data pin Data+ and the second data pin Data− of the second socket 401. The power display module 406 is provided on the surface of the charge apparatus 40, and is electrically connected to the power processing module 405.

Referring to FIG. 3(b), the rechargeable battery further includes a charge control module 313, a capacity storage module 314, a discharge control module 315 and a power measurement module 316. The capacity storage module is configured for storing capacity, and the charge control module 313, the discharge module 315 and the power measurement module 316 are all electrically connected to the capacity storage module 314.

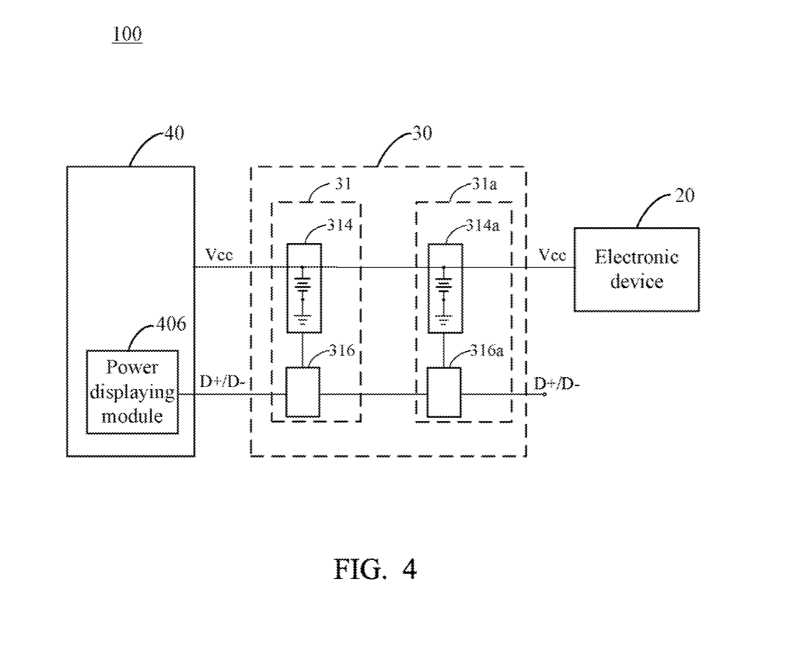

In the embodiment, the charge control module 313 is electrically connected to the power pin VCC and the ground pin GND of the plug 311. The charge control module 313 is configured for receiving the low-voltage direct current output from the charge apparatus 40, and charging the capacity storage module 314. The discharge control module 315 is electrically connected to the power pin VCC and the ground pin GND of the first socket 312, and is configured for controlling the capacity storage module 314 to supply power to the electronic device 20 when the rechargeable battery 31 is electrically connected to the electronic device 20. In the embodiment, inside each battery, the power pin VCC and the ground pin GND of the plug 311 are electrically connected to the power pin VCC and the ground pin GND of the first socket 312 correspondingly. With such structure, a number of these rechargeable batteries, for example, as shown in FIG. 4, the rechargeable battery 31 and 31a are plugged together to consist the parallel battery pack 30. The charge apparatus 40 can charge the rechargeable battery at the same time, and the rechargeable batteries can also supply power to the electronic device 20 together.

Referring again to FIG. 3(b), the power measurement module 316 is configured for measuring the residual capacity value of the capacity storage module 314. The power measurement module 316 is also electrically connected to the first data pin Data+ and the second data pin Data− of the plug 311. In addition, is configured to feed back a reference capacity value and the measured actual residual capacity value of the capacity storage module 314 to the power processing module 405 of the charge apparatus 40 via the first data pin Data+and the second data pin Data− of the plug 311, when the rechargeable battery 31 is coupled to the charge apparatus 40. The reference capacity value is a full charge capacity value of the rechargeable battery.

In the embodiment, the power measurement module 316 is also electrically connected to the first date pin Data+ and the second data pin Data− of the first socket 312. When a number of these rechargeable batteries are plugged together, the power measurement modules 316 of the battery pack 30 communicate with each other via the first data pin Data+ and the second data pin Data− of the plug 311 and the first socket 312, and the one which is directly connected to the charge apparatus 40, feedbacks a total reference capacity value and the total measured actual residual capacity value of the battery pack 30 to the power processing module 405 of the charge apparatus 40.

FIG. 3(a) also shows that the power processing module 405 is configured to receive the total reference capacity value and the total actual residual capacity value of the battery pack 30. In addition, calculate a ratio of the total actual residual capacity value with respect to the total reference capacity value of the battery pack 30, and output a corresponding control signal to control the power display module 406 to display the ratio.

In the embodiment, the power display module 406 is a light-emitting diode (LED) pack, and includes a number of LEDs. All or part of these LEDs may be illumined to indicate the ratio.

In an alternative embodiment, the power display module 406 can be a liquid crystal display module or other type display module.

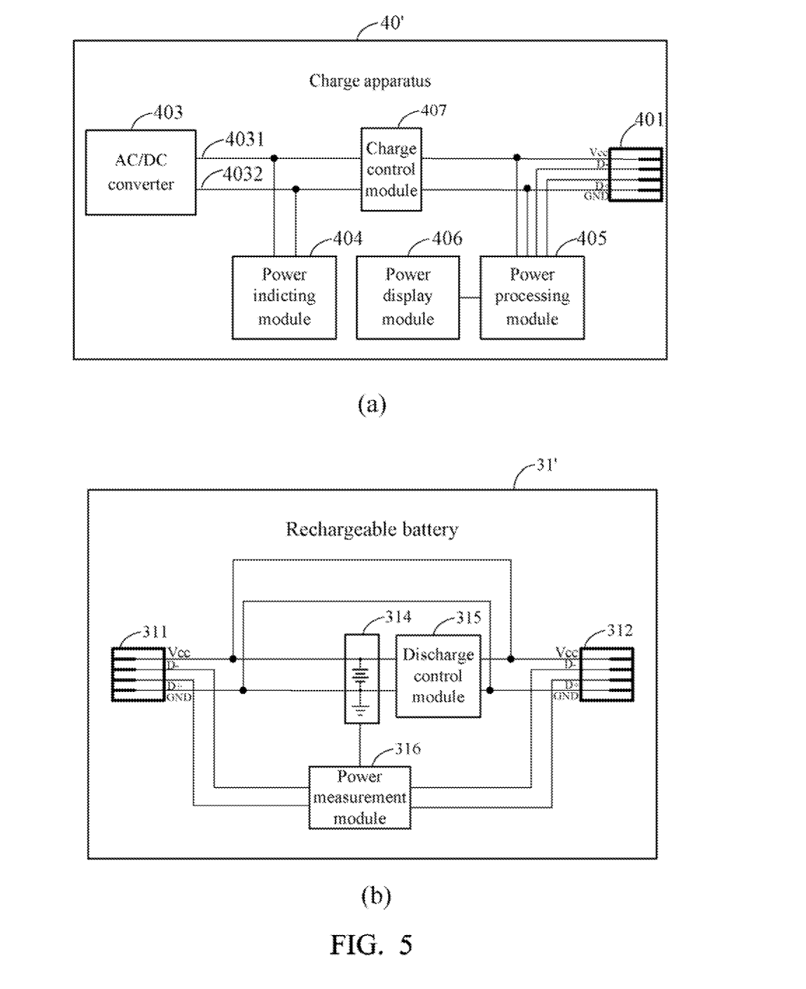

In an alternative embodiment, as shown in FIG. 5, a charge control module 407 is provided in the charge apparatus 40′, which is electrically connected to the voltage output pins 4031, 4032 of the AC/DC converter 403 and the power pin VCC and the ground pin GND of the second socket 401. In addition, is configured for charging the rechargeable battery of the battery pack 30. The rechargeable battery 31′ includes the capacity storage module 314, the discharge control module 315, and a power measurement module 316. In another embodiment, the rechargeable battery 31′ only includes the capacity storage module 314 and the power measurement module 316, and the rechargeable battery 31′ supplies power to the electronic device 20 via a discharge control module provided in the electronic device 20.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A power supply system comprising
an electronic device,
a battery pack and
a charge apparatus, wherein the charge apparatus is configured for charging the battery pack, and the battery pack is configured for supplying power to the electronic device; the battery pack comprises a plurality of rechargeable batteries, each of the rechargeable batteries comprising:
a plug and a first socket, wherein the rechargeable batteries are configured to be assembled together by insertion of the plug of one rechargeable battery into the first socket of another rechargeable battery, to constitute the battery pack, and an unoccupied plug of the battery pack is configured to be plugged in a second socket of the charge apparatus to connect the battery pack to the charge apparatus, an unoccupied first socket of the battery pack is configured to be electrically coupled to a power input port of the electronic device;
a capacity storage module configured for storing capacity; and
a power measurement module electrically connected to the capacity storage module, the power measurement module being configured to measure a residual capacity value of the capacity storage module, and feedback the measured residual capacity value to the charge apparatus when the battery pack is electrically connected to the charge apparatus.

2. The power supply system as described in claim 1, wherein the power measurement modules of the battery pack communicate with each other, and one of the power measurement modules which is directly connected to the charge apparatus is configured to feed back the total measured residual capacity value of the battery pack to the charge apparatus, when the battery pack is electrically connected to the charge apparatus.

3. The power supply system as described in claim 2, wherein the power measurement module which is directly connected to the charge apparatus is configured to feed back a total reference capacity value of the battery pack to the charge apparatus, the charge apparatus comprises a power processing module and a power display module, the power processing being configured to receive the total reference capacity value and the total residual capacity value of the battery pack, and calculate a ratio of the total residual capacity value with respect to the total reference capacity value of the battery pack, and output a corresponding control signal to control the power display module to display the ratio.

4. The power supply system as described in claim 1, wherein the plug is a USB connector, the first socket and the second socket are USB sockets, each of the USB connector and the USB socket includes a power pin, a first data pin, a second data pin and a ground pin, and inside each of the at least one batteries, the power pin and the ground pin of the plug are electrically connected to the power pin and the ground pin of the first socket correspondingly.

5. The power supply system as described in claim 1, wherein the plug and the first socket are arranged on opposite end surfaces of each of the rechargeable batteries.

6. The power supply system as described in claim 1, wherein each of the rechargeable batteries further comprises a charge control module electrically connected to the capacity storage module, the charge control module being configured for receiving a low-voltage direct current output from the charge apparatus and charging the capacity storage module.

7. The power supply system as described in claim 1, wherein each of the rechargeable batteries further comprises a discharge control module electrically connected to the capacity storage module, the discharge control module being configured for controlling the capacity storage module to supply power to the electronic device, when the rechargeable battery is electrically connected to the electronic device.

8. The power supply system as described in claim 1, wherein the charge apparatus comprises a charge control module, which is configured for charging each of the rechargeable batteries.

9. A rechargeable battery comprising:
a plug and a first socket, the plug configured for being plugged in either a first socket of a second similar rechargeable battery to constitute a battery pack or a second socket of a charge apparatus, and the first socket configured for either receiving a plug of a third similar rechargeable battery, to constitute the battery pack or being electrically coupled to a power input port of an electronic device;
a capacity storage module configured for storing capacity; and
a power measurement module electrically connected to the capacity storage module, the power measurement module being configured to measure a residual capacity value of the capacity storage module, and feedback the measured residual capacity value to the charge apparatus when the battery pack is electrically connected to the charge apparatus.

10. The rechargeable battery as described in claim 9, wherein the power measurement module of the rechargeable battery communicates with the power measurement modules of the at least one another battery, to feed back the total measured residual capacity value of the battery pack to the charge apparatus, when the battery pack is electrically connected to the charge apparatus.

11. The rechargeable battery as described in claim 9, wherein the plug is a USB connector, the first socket is a USB socket, each of the USB connector and the USB socket includes a power pin, a first data pin, a second data pin and a ground pin, and inside the rechargeable battery, the power pin and the ground pin of the plug are electrically connected to the power pin and the ground pin of the first socket correspondingly.

12. The rechargeable battery as described in claim 9, wherein the plug and the first socket are arranged on opposite end surfaces of the rechargeable battery.

13. The rechargeable battery as described in claim 9, wherein the rechargeable battery further comprises a charge control module electrically connected to the capacity storage module, the charge control module being configured for receiving a low-voltage direct current output from the charge apparatus and charging the capacity storage module.

14. The rechargeable battery as described in claim 9, wherein the rechargeable battery further comprises a discharge control module electrically connected to the capacity storage module, the discharge control module being configured for controlling the capacity storage module to supply power to the electronic device, when the rechargeable battery is electrically connected to the electronic device.
